(19) United States
(12) Patent Application Publication
(10) Pub. No.: US 2018/0241236 A1
(43) Pub. Date: Aug. 23, 2018

(54) HOT-SWAPPABLE BATTERY PACK

(71) Applicant: Goal Zero LLC, Bluffdale, UT (US)

(72) Inventors: Keyvan Vasefi, Payson, UT (US); Scott Stewart, Henderson, NV (US); Gilbert De Guzman, Henderson, NV (US); David Gurtner, Las Vegas, NV (US)

(73) Assignee: Goal Zero LLC, Bluffdale, UT (US)

(21) Appl. No.: 15/902,733

(22) Filed: Feb. 22, 2018

Related U.S. Application Data
(60) Provisional application No. 62/462,635, filed on Feb. 23, 2017.

(51) Int. Cl. H02J 7/00; H01M 2/10

(52) U.S. Cl. CPC H02J 7/0068; H02J 7/0021; H01M 2/1016

(57) ABSTRACT

A battery pack includes a housing, one or more battery cells disposed within the housing, a power interface including one or more connectors, the one or more connectors configured to engage with an interface of an external device to at least one of charge the one or more battery cells and provide power from the one or more battery cells to the external device, and switching circuit. The switching circuit includes a limited flow circuit and a bypass circuit arranged in parallel between, and at least selectively electrically coupling, the one or more battery cells and the power interface. The limited flow circuit includes a resistor configured to at least selectively limit a current flow between the one or more battery cells and the power interface. The bypass circuit includes a switch configured to selectively place the one or more battery cells in direct electrical communication with the power interface.

### CROSS-REFERENCE TO RELATED PATENT APPLICATIONS

This application claims the benefit of U.S. Provisional Patent Application No. 62/462,635, filed Feb. 23, 2017, which is incorporated herein by reference in its entirety.

### BACKGROUND

Power supply devices may include a plurality of interchangeable battery packs. Traditional power supply devices may need to be powered off when adding, removing, and/or replacing one or more of the interchangeable battery packs. A discontinuous supply of electricity may thereby be provided to electrically connected devices by such traditional power supply devices, producing undesired down time.

### SUMMARY

One embodiment relates to a battery pack. The battery pack includes a housing, one or more battery cells disposed within the housing, a power interface including one or more connectors, the one or more connectors configured to engage with an interface of an external device to at least one of charge the one or more battery cells and provide power from the one or more battery cells to the external device, and switching circuit. The switching circuit includes a limited flow circuit and a bypass circuit arranged in parallel between, and at least selectively electrically coupling, the one or more battery cells and the power interface. The limited flow circuit includes a resistor configured to at least selectively limit a flow of current between the one or more battery cells and the power interface. The bypass circuit includes a switch configured to selectively place the one or more battery cells in direct electrical communication with the power interface.

Another embodiment relates to a power supply system. The power supply system includes an electric device having a power bus including a plurality of power interfaces and a plurality of battery packs. Each of the plurality of battery packs includes one or more battery cells, a connector configured to selectively couple to one of the plurality of power interfaces, a first circuit including at least one of a resistor and a first switch, a second circuit including a second switch, and a controller. The first circuit is arranged in parallel with the second circuit between the one or more battery cells and the connector. The controller is configured to control activation of at least one of the first switch and the second switch such that each of the plurality of battery packs are selectively engagable with and selectively disengagable from the power bus without impacting operation of the electric device device.

Still another embodiment relates to a method for hot-swapping battery packs from an external device having a first battery pack and a second battery pack coupled thereto. The method includes removing the first battery pack from a first power interface of the external device while leaving the second battery pack coupled to a second power interface of the external device; coupling a third battery pack to the first power interface or a third power interface, the third battery pack including a switching circuit having (i) a first circuit including at least one of a resistor and a first switch and (ii) a second circuit in parallel with the first circuit and including a second switch; monitoring, by a processing circuit of the third battery pack, at least one of a current flowing through the first circuit, an internal voltage of the third battery pack, and an external voltage of the external device; and reconfiguring, by the processing circuit, the switching circuit from a limited mode, where the current flows through the resistor of the first circuit, to an unrestricted mode such that the current flows through the second circuit unrestricted by the resistor of the first circuit in response to at least one of (i) a difference between the internal voltage and the external voltage being less than a threshold voltage amount and (ii) the current dropping below a threshold current level. Reconfiguring the switching circuit from the limited mode to the unrestricted mode includes at least one of closing the second switch and opening the first switch.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic view of a power supply system having a power bus and a plurality of swappable battery packs, according to an exemplary embodiment;

FIG. 2 is a schematic view of a swappable battery pack, according to an exemplary embodiment;

FIG. 3 is a flow diagram of a method for interchanging battery packs of a power supply device, according to an exemplary embodiment; and

FIG. 4 is a flow diagram of a method for interchanging battery packs of a power supply device, according to another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a battery pack includes a battery and a switching circuit. The battery pack is configured to selectively engage a power supply device to provide power thereto from a battery thereof. According to an exemplary embodiment, the switching circuit is configured to facilitate selectively interchanging battery packs (e.g., adding battery packs to and/or removing battery packs from the power supply device, etc.) without shutting down the power supply device. The battery packs may thereby be configured as hot- swappable battery packs that facilitating continuous and uninterrupted operation of the power supply device.

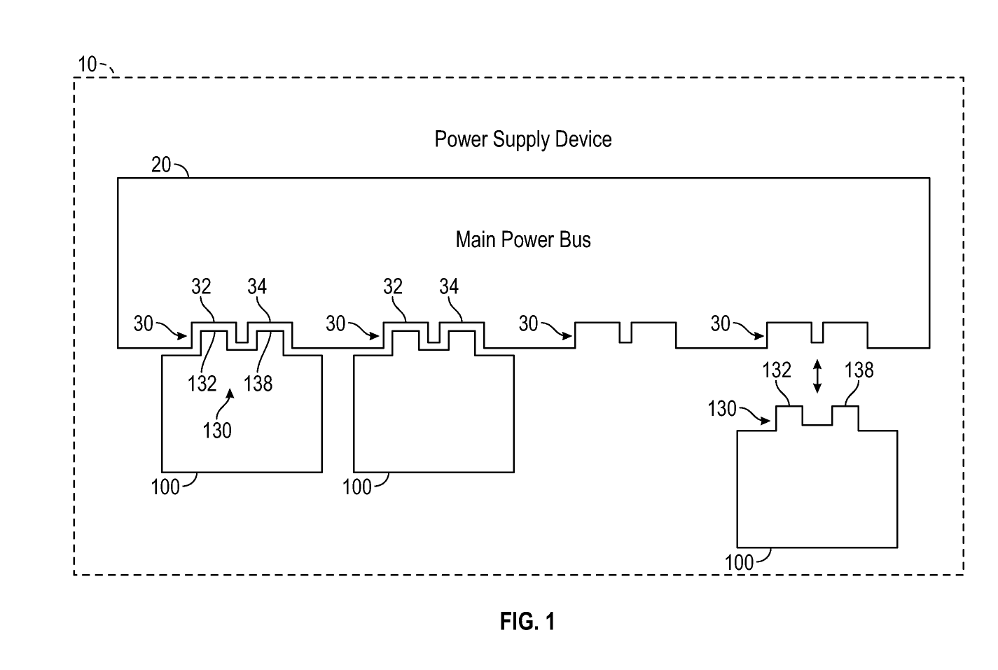

According to the exemplary embodiment shown in FIG. 1, a power supply system (e.g., an electric/solar generator, an energy storage and power supply device, etc.), shown as power supply device 10, includes a power bus, shown as main power bus 20, having a plurality of interfaces, shown as battery interfaces 30. In one embodiment, the battery interfaces 30 are configured to detachably receive one or more energy storage devices, shown as battery packs 100. According to an exemplary embodiment, the battery interfaces 30 are electrically connected in parallel to the main power bus 20. The power supply device 10 is configured to remain powered on (e.g., operating; powering one or more end user devices such as a smartphone, a tablet, an E-reader, a computer, a laptop, a smartwatch, a portable and rechargeable battery pack, appliances, refrigerators, lights, display monitors, televisions, or other electronic devices; etc.) while one or more of the battery packs 100 are selectively coupled to and/or decoupled from the main power bus 20, according to an exemplary embodiment. The battery packs 100 may thereby be added to and/or removed from the battery interfaces 30 without shutting down (e.g., by a user, automatically, etc.) the main power bus 20 (e.g., providing hot-swappable battery packs, etc.), thereby facilitating continuous and uninterrupted operation of the power supply device 10.

As shown in FIG. 1, each of the battery interfaces 30 includes a first interface (e.g., a first connector, a power connector, a first port, a power port, etc.), shown as power interface 32, and a second interface (e.g., a second connector, a data connector, a communication connector, a second port, a data port, a communication port, etc.), show as communication interface 34. In other embodiments, one or more of the battery interfaces 30 do not include the second interface. According to an exemplary embodiment, each of the power interfaces 32 of the main power bus 20 is configured to facilitate receiving power (e.g., stored chemical energy converted to electrical energy, etc.) from a respective battery pack 100 as part of operating the power supply device 10 (e.g., the power interfaces 32 may include one or more connectors, etc.). According to an exemplary embodiment, each of the communication interfaces 34 of the main power bus 20 is configured to facilitate sending data regarding the operation of the power supply device 10 (e.g., voltage, current, loading, etc.) to the battery packs 100 and/or receiving data regarding the operation of a respective battery pack 100 (e.g., voltage, current, loading, state of charge, mode of operation, etc.) from the respective battery pack 100. In some embodiments, the communications interface 34 is, includes, and/or facilitates a wireless connection (e.g., a wireless transceiver, etc.).

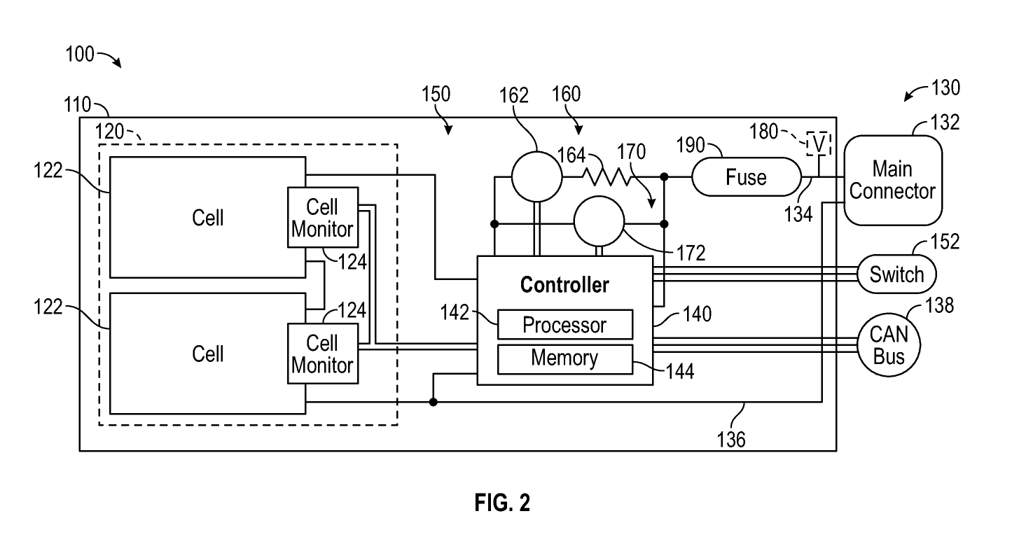

As shown in FIG. 2, each of the battery packs 100 includes a body, shown as housing 110, configured to receive and store an energy storage device (e.g., a rechargeable battery, etc.), shown as battery 120, a controller (e.g., a battery management system (“BMS”), etc.), shown as battery controller 140, and a circuit, shown as switching circuit 150. In other embodiments, the battery pack(s) 100 do not include battery controller 140.

As shown in FIGS. 1 and 2, the battery pack 100 includes an interface, shown as connection interface 130, configured to interface with the battery interfaces 30 of the power supply device 10. The connection interface 130 of the battery pack 100 includes a first interface (e.g., a first connector, a power connector, a first port, a power port, a main connector, etc.), shown as power interface 132, and a second interface (e.g., a second connector, a data connector, a communication connector, a second port, a data port, a communication port, a controller area network (“CAN”) bus, etc.), show as communication interface 138. Power interface 132 may include one or more connectors. In other embodiments, one or more of the connection interfaces 130 do not include the second interface. In still other embodiments, the communications interface 138 is, includes, and/or facilitates a wireless connection (e.g., a wireless transceiver, etc.).

As shown in FIG. 2, the battery 120 includes a plurality of cells (e.g., two or more batteries cells connected in series, etc.), shown as battery cells 122, electrically coupled to the power interface 132 with a first terminal, shown as positive terminal 134, and a second terminal, shown as negative terminal 136, of the power interface 132. In other embodiments, the battery 120 includes one battery cell 122. In one embodiment, the battery 120 is and/or includes lithium iron phosphate (“LiFePo”) battery cells. In other embodiments, the battery 120 additionally or alternatively includes a different type of battery cell (e.g., lithium-ion (“Li-ion”) battery cell(s), nickel cadmium (“NiCd”) battery cell(s), nickel-metal hydride (“NiMH”) battery cell(s), lead acid battery cell(s), etc.). In still other embodiments, the battery pack 100 additionally or alternatively includes one or more capacitors. According to an exemplary embodiment, the battery cells 122 are configured to receive electrical energy from a charging device (e.g., a battery charging device, a solar panel, a mains power supply, etc.) selectively connected to the power interface 132 and store the energy (e.g., convert the electrical energy to chemical energy, etc.) for future use by an electronic device (e.g., the power supply device 10, etc.). As shown in FIG. 1, the power interface 132 of each of the battery packs 100 is configured to selectively interface with (e.g., be received by, etc.) a respective power interface 32 of the power supply device 10, thereby electrically coupling the battery 120 thereof to the main power bus 20 to provide power from the battery packs 100 to the power supply device 10.

As shown in FIG. 2, the switching circuit 150 selectively couples the positive terminal 134 of the power interface 132 and the battery 120. In other embodiments, the switching circuit 150 selectively couples the negative terminal 136 of the power interface 132 and the battery 120. As shown in FIG. 2, the switching circuit 150 includes a first circuit, shown as limited flow circuit 160, and a second circuit, shown as bypass circuit 170. As shown in FIG. 2, the limited flow circuit 160 includes a first switch element, shown as equalizing contactor 162, and a resistive element, shown as equalizing resistor 164. The bypass circuit 170 includes a second switch element, shown as bypass contactor 172. According to an exemplary embodiment, the equalizing contactor 162 is configured to be selectively activated (e.g., switched on, closed, etc. such that the limited flow circuit 160 couples the battery 120 and the power interface 132, etc.) to draw the power provided by the battery 120 and/or charge the battery 120 through the limited flow circuit 160 and the equalizing resistor 164, while the bypass contactor 172 is selectively deactivated (e.g., switched off, open, etc. such that that the bypass circuit 170 forms an open circuit between the battery 120 and the power interface 132, etc.). The equalizing resistor 164 may thereby be positioned and/or configured to control (e.g., modulate, limit, throttle, etc.) a flow of current into and/or out of the battery 120 through the power interface 132. According to an exemplary embodiment, the bypass contactor 172 is configured to be selectively activated (e.g., switched on, etc. such that the bypass circuit 170 couples the battery 120 and the power interface 132, etc.) to facilitate drawing power provided by the battery 120 and/or charging the battery 120 through the bypass circuit 170.

In some embodiments, the equalizing contactor 162 and the bypass contactor 172 are configured to remain deactivated (e.g., open, etc.) until receiving a signal from the battery controller 140 to activate (e.g., close, etc.). In other embodiments, at least one of the equalizing contactor 162 and the bypass contactor 172 are activated at all times. In one embodiment, the equalizing contactor 162 is a normally closed switch, and the bypass contactor 172 is a normally open switch. The equalizing contactor 162 may be activated when the bypass contactor 172 is deactivated, and the equalizing contactor 162 may be deactivated when the bypass contactor 172 is activated (e.g., activation of the equalizing contactor 162 and the bypass contactor 172 may be tied together by a single energizing coil, etc.). In another embodiment, the equalizing contactor 162 and the bypass contactor 172 are independently controlled. The equalizing contactor 162 may thereby be either activated or deactivated while the bypass contactor 172 is activated (e.g., the state of the equalizing contactor 162 may not affect the operation of the switching circuit 150 while the bypass contactor 172 is activated due to power flow through the bypass circuit 170 from reduced resistance, etc.). In some embodiments, the limited flow circuit 160 does not include the equalizing contactor 162. By way of example, the limited flow circuit 160 may always be closed, however, the power provided by the battery 120 may flow through the bypass circuit 170 while the bypass contactor 172 is activated (e.g., due to the equalizing resistor 164 of the limited flow circuit 160, etc.).

As shown in FIG. 2, the battery pack 100 includes a switch (e.g., an on/off switch, a power switch, etc.), shown as switch 152. In one embodiment, the switch 152 is accessible from outside the housing 110. The switch 152 is coupled to the battery controller 140. According to an exemplary embodiment, the switch 152 is configured to facilitate manually activating and/or deactivating at least one of the equalizing contactor 162 and the bypass contactor 172. By way of example, the battery controller 140 may be configured to send a signal to the equalizing contactor 162 to activate and thereby close the limited flow circuit 160 in response to an indication that the switch 152 has been manually engaged (e.g., turning the battery pack 100 on, to facilitate the flow of current between the battery 120 and the power interface 132 through the limited flow circuit 160, etc.). By way of another example, the battery controller 140 may be configured to send a signal to the equalizing contactor 162 and/or the bypass contactor 172 (e.g., whichever of the equalizing contactor 162 and the bypass contactor 172 are currently activated, etc.) to deactivate and thereby open the limited flow circuit 160 and/or the bypass circuit 170, respectively, in response to the external switch being manually disengaged (e.g., turning the battery pack 100 off, to prevent the flow of current between the battery 120 and the power interface 132 through the switching circuit 150, to completely decouple the battery 120 and the power interface 132, etc.). In other embodiments, the battery pack 100 does not include the switch 152.

As shown in FIG. 2, the battery pack 100 includes a fuse, shown as fuse 190, positioned between the switching circuit 150 and the positive terminal 134 of the power interface 132. According to an exemplary embodiment, the fuse 190 is configured to provide overcurrent protection in the event that an excessive amount of current is drawn from and/or provided to the battery 120 (e.g., to prevent the battery pack 100 from experiencing damage, etc.). In other embodiments, the battery pack 100 does not include the fuse 190.

As shown in FIG. 2, the communication interface 138 of the battery pack 100 is communicably coupled to the battery controller 140 such that data may be received by the battery controller 140 with the communication interface 138 from an external device (e.g., the power supply device 10, a charging device, etc.) and/or data may be transmitted to the external device (e.g., the power supply device 10, the charging device, etc.) by the battery controller 140 with the communication interface 138. As shown in FIG. 1, the data interface 138 of each of the battery packs 100 is configured to selectively interface with (e.g., be received by, etc.) a respective communication interface 34 of the power supply device 10, thereby communicably coupling the battery packs 100 to the main power bus 20 to facilitate data communication therebetween (e.g., the power supply device 10 and the battery controller 140, using a wired communication protocol, etc.). In other embodiments, the communication interface 138 additionally or alternatively is configured to facilitate wireless communication with the power supply device 10 and/or another device (e.g., a charging device, etc.) to facilitate data communication therebetween (e.g., using a wireless communication protocol such as Bluetooth, radio, ZigBee, near field communication (“NFC”), Wi-Fi, RFID, etc.).

As shown in FIG. 2, the battery pack 100 includes a voltage sensor 180. The voltage sensor 180 is positioned on and/or proximate the positive terminal 134 of the power interface 132, according to the exemplary embodiment shown in FIG. 2. According to an exemplary embodiment, the voltage sensor 180 is positioned to acquire data regarding the voltage at the main power bus 20 of the power supply device 10 (e.g., when the power interface 132 of the battery pack 100 is engaged with the power interface 32 of the main power bus 20, etc.). In such an embodiment, the battery pack 100 may be configured to monitor the voltage of the main power bus 20 without communicating with the power supply device 10 (e.g., with the communication interface 138, etc.). In other embodiments, the battery pack 100 does not include the voltage sensor 180. In such an embodiment, the battery pack 100 may be configured to receive voltage information from the power supply device 10 (e.g., with the communication interface 138, etc.).

As shown in FIG. 2, the battery 120 includes one or more sensors, shown as cell monitors 124. In one embodiment, the cell monitors 124 are associated with and coupled to each battery cell 122 and the battery controller 140. According to an exemplary embodiment, the cell monitors 124 are positioned and/or configured to acquire data regarding the battery cells 122 (e.g., state of charge, current draw, current intake and/or charge current, voltage, etc.) and provide such data to the battery controller 140.

According to an exemplary embodiment, the battery controller 140 is configured to selectively engage, selectively disengage, control, and/or otherwise communicate with components of the battery pack 100 and/or the power supply device 10. As shown in FIG. 2, the battery controller 140 is coupled to the cell monitors 124, the communication interface 138, the switch 152, the equalizing contactor 162, the bypass contactor 172, and the voltage sensor 180. In other embodiments, the battery controller 140 is coupled to more or fewer components. The battery controller 140 may be configured selectively control which of the equalizing contactor 162 and the bypass contactor 172 is activated or deactivated (e.g., one, both, neither, etc.) based on various inputs and/or data (e.g., voltage data, current data, inputs from the switch 152, etc.) to facilitate hot-swapping the battery packs 100 from the main power bus 20 (e.g., to provide continuous and uninterrupted operation of the power supply device 10, etc.). By way of example, the battery controller 140 may send and receive signals with the cell monitors 124, the communication interface 138, the external switch 152, the equalizing contactor 162, the bypass contactor 172, and/or the voltage sensor 180.

As shown in FIG. 2, the battery controller 140 includes a processor 142 and a memory 144 (e.g., RAM, ROM, Flash Memory, hard disk storage, etc.). The processor 142 may be implemented as a general-purpose processor, an application specific integrated circuit (“ASIC”), one or more field programmable gate arrays (“FPGAs”), a digital signal processor (“DSP”), a group of processing components, or other suitable electronic processing components. The memory 144 may include multiple memory devices. The memory 144 may store data and/or computer code for facilitating the various processes described herein. Thus, the memory 144 may be communicably connected to the processor 142 and provide computer code or instructions to the processor 142 for executing the processes described in regard to the battery controller 140 herein. Moreover, the memory 144 may be or include tangible, non-transient volatile memory or non-volatile memory. Accordingly, the memory 144 may include database components, object code components, script components, or any other type of information structure for supporting the various activities and information structures described herein.

According to an exemplary embodiment, the battery controller 140 is configured to deactivate both the equalizing contactor 162 and the bypass contactor 172 in response to an indication that the switch 152 is in an off configuration (e.g., the battery pack 100 is off, etc.) and/or while the battery pack 100 is disengaged from the power supply device 10. In one embodiment, the battery controller 140 is configured to activate the equalizing contactor 162 in response to an indication that the switch 152 is engaged (e.g., after the battery pack 100 is coupled to the main power bus 20, etc.). In another embodiment, the battery controller 140 is configured to automatically activate the equalizing contactor 162 in response to the power interface 132 of the battery pack 100 engaging with one of the power interfaces 32 of the main power bus 20. In still another embodiment, the battery controller 140 is configured to keep the equalizing contactor 162 activated at all times until a condition is met and thereafter activate the bypass contactor 172 (e.g., the equalizing contactor 162 is a normally closed switch, etc.). Activating and/or having the equalizing contactor 162 activated when the battery pack 100 is first coupled to the main power bus 20 may prevent undesirable operating conditions for the battery pack 100. By way of example, having the equalizing contactor 162 activated while the bypass contactor 172 is deactivated causes the current from the battery 120 to flow through the equalizing resistor 164 of the limited flow circuit 160, which may thereby limit (e.g., throttle, etc.) the current input and/or output to and/or from the battery pack 100. Advantageously, such operation may prevent an undesirable, high current charge to and/or discharge from the battery 120 which may otherwise trip the fuse 190 and/or expose the battery 120 to excessive strain.

According to an exemplary embodiment, the battery controller 140 is configured to receive current data from the cell monitors 124 regarding the current being drawn from and/or being provided to the switching circuit 150 by the battery 120. The battery controller 140 may be configured to monitor the current draw and compare the current draw to a target current level (e.g., a current threshold, etc.). The battery controller 140 may be additionally or alternatively configured to monitor a charge current and compare the charge current to a target current level (e.g., a current threshold, etc.). The battery controller 140 may be configured to activate the bypass contactor 172 in response to the current draw from the battery 120 and/or the charging current being provided to the battery 120 meeting the target current level (e.g., falling below the current threshold, etc.). The current may thereby bypass the limited flow circuit 160 in favor of the bypass circuit 170 such that the battery pack 100 provides unrestricted power to the main power bus 20 and/or the battery pack 100 is charged with unrestricted power. The battery controller 140 may or may not deactivate the equalizing contactor 162 in response to the current draw from the battery 120 and/or the charge current meeting the target current level.

In some embodiments, the battery controller 140 is additionally or alternatively configured to compare the voltage on the main power bus 20 (i.e., a voltage external to the battery pack 100) to the voltage of the battery 120 (i.e., a voltage internal to the battery pack 100) and determine whether to activate the equalizing contactor 162 and/or the bypass contactor 172. By way of example, the battery controller 140 may be configured to receive voltage data from the cell monitors 124 regarding the voltage within the battery pack 100 (e.g., the internal voltage, the voltage of the battery 120, etc.). By way of another example, the battery controller 140 may be configured to receive voltage data from the voltage sensor 180 and/or the communication interface 138 regarding the voltage on the main power bus 20 (e.g., the external voltage, etc.).

According to an exemplary embodiment, the battery controller 140 is configured to activate the equalizing contactor 162 in response to determining that the internal voltage of the battery pack 100 is greater than the external voltage of the main power bus 20 (e.g., a difference between the internal voltage and the external voltage is more than a threshold voltage amount, etc.). Activating the equalizing contactor 162 in response to the internal voltage of the battery pack 100 being greater than the external voltage by a threshold voltage amount (e.g., the threshold voltage amount may be any threshold greater than zero volts, etc.) may (i) prevent the fuse 190 from tripping, (ii) extend the charge of the battery 120 (e.g., prevent the battery 120 from discharging too quickly, etc.), (iii) thermally regulate the temperature of the battery 120 (e.g., prevent the battery 120 from heating up too much, etc.), and/or (iv) extend the life cycle of the battery 120, among other various advantages. According to an exemplary embodiment, the battery controller 140 is configured to activate the bypass contactor 172 in response to determining that a difference between the internal voltage of the battery pack 100 and the external voltage of the main power bus 20 is less than the threshold voltage amount and/or greater than a minimum internal voltage (e.g., the internal voltage of the battery 120 and the external voltage of the main power bus 20 are similar and/or within a predefined range of one another, etc.).

According to an exemplary embodiment, the battery controller 140 is configured to deactivate the equalizing contactor 162 and/or the bypass contactor 172 when the battery pack 100 is disconnected from the battery interface 30. In one embodiment, the battery controller 140 is configured to deactivate the equalizing contactor 162 and/or the bypass contactor 172 in response to disengagement of the switch 152 (e.g., based on a signal therefrom, etc.). In some embodiments, the battery controller 140 is additionally or alternatively configured to deactivate the equalizing contactor 162 and/or the bypass contactor 172 in response to detecting that the battery pack 100 has been disconnected from the battery interface 30.

According to an exemplary embodiment, the battery packs 100 include a display disposed on the housing 110. The display may provide various information regarding the state and/or operation of the power supply device 10 and/or the battery pack 100 (e.g., a battery level, a current input power, a current input voltage, a current input current, a current output power, a current output voltage, a current output current, an estimated time until a full charge state of the battery 120 is reached, an estimated time until full depletion state of the battery 120 is reached, a battery temperature, an insignia, a notification, a warning, etc.).

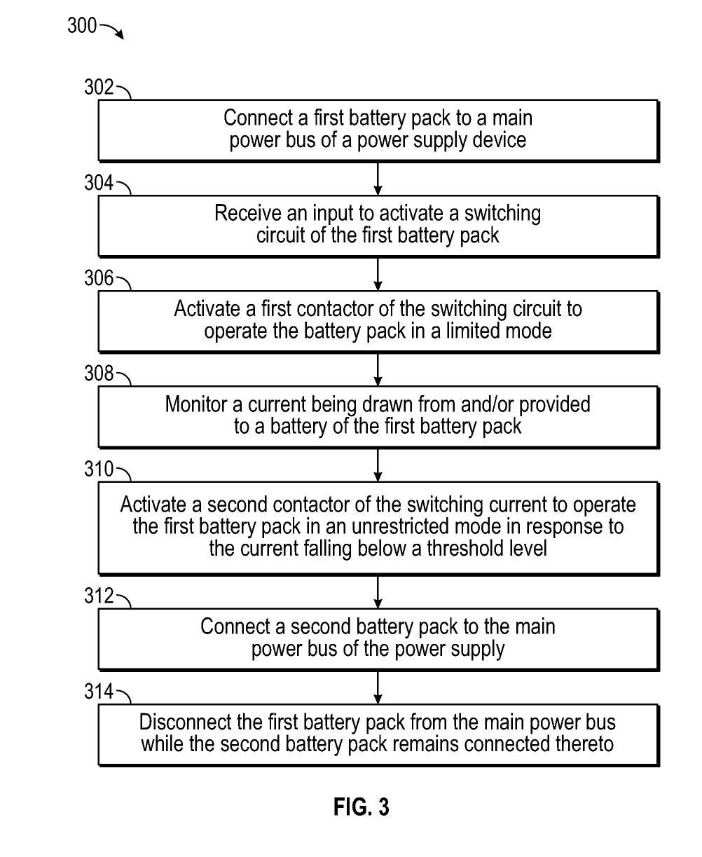

Referring now to FIG. 3, a method 300 for interchanging battery packs of a power supply device is shown according to an exemplary embodiment. In one exemplary embodiment, method 300 may be implemented with the battery pack 100 and the power supply device 10 of FIGS. 1 and 2. As such, method 300 may be described with regard to FIGS. 1 and 2.

At step 302, a first battery pack (e.g., the battery pack 100, etc.) is connected to a first interface (e.g., the power interface 32, the communication interface 34, etc.) of a main power bus (e.g., the main power bus 20, etc.) of a power supply device (e.g., the power supply device 10, etc.). At step 304, a controller (e.g., a BMS, the battery controller 140, etc.) of the first battery pack receives an input to activate a switching circuit (e.g., the switching circuit 150, etc.) of the first battery pack. By way of example, the input may include a signal received by the controller from a switch (e.g., the switch 152, etc.) of the first battery pack in response to an operator of the power supply device engaging the switch. In other embodiments, the input is received by another device (e.g., the first battery pack may or may not include a controller, etc.). In still other embodiments, the switch is configured to provide a signal in response to engagement thereof by an operator of the first battery pack (e.g., the switch may provide the signal regardless of whether or not it is associated with a power supply device, etc.). By way of another example, the input may include a signal received by the controller from a sensor and/or a communication interface (e.g., the communication interface 138, etc.) of the battery pack indicating a connection between the first battery pack and the main power bus.

At step 306, the controller is configured to activate a first contactor (e.g., the equalizing contactor 162, etc.) of the switching circuit to operate the battery pack in a limited mode. By way of example, activating the first contactor may direct current from a battery (e.g., the battery 120, etc.) to flow through a first circuit (e.g., the limited flow circuit 160, etc.) of the switching circuit prior to being provided to the main power bus (e.g., through the power interface 132, etc.). The first circuit may include a resistive element (e.g., the equalizing resistor 164, etc.) positioned and/or configured to modulate (e.g., limit, throttle, etc.) the current provided by the battery to the main power bus during the limited mode of operation.

At step 308, the controller is configured to monitor the current being drawn from and/or provided to the battery of the first battery pack (e.g., the current that is flowing through the limited flow circuit 160, with the cell monitors 124, etc.). At step 310, the controller is configured to activate a second contactor (e.g., the bypass contactor 172, etc.) of the switching circuit to operate the first battery pack in an unrestricted mode in response to the current being provided by the battery falling below a threshold current level (e.g., leveling out, reducing from an initial high current output in response to initial connection to the main power bus 20, etc.). By way of example, activating the second contactor may direct current from the battery to flow through a second circuit (e.g., the bypass circuit 170, etc.) that bypasses the resistive element. In some embodiments, the controller is configured to deactivate the first contactor when the second contactor is activated. In other embodiments, the controller does not deactivate the first contactor while the second contactor is activated.

At step 312, a second battery pack is connected to a second interface of the main power bus of the power supply device. The controller of the second battery pack may perform steps 304-310 similar to the controller of the first battery pack. At step 314, the first battery pack is disconnected from the main power bus while the second battery pack remains connected thereto (e.g., the power interface 132 of the battery pack 100 is disengaged from the power interface 32 of the power supply device 10, etc.). In one embodiment, disconnecting the first battery pack includes manually disengaging the switch. In another embodiment, disconnecting the first battery pack automatically disengages the switch. The controller may be configured to deactivate the first contactor and/or the second contactor in response to disengagement of the switch. In embodiments where the first battery pack may not include the switch, a signal may be sent to the controller from a sensor and/or a communication interface (e.g., the communication interface 138, etc.) of the first battery pack indicating a connection between the first battery pack and the main power bus has been disconnected. According to an exemplary embodiment, the battery packs facilitate interchangeably swapping battery packs such that the main power bus does not need to be powered down (e.g., hot-swappable battery packs, etc.), thereby being capable of providing continuous and uninterrupted power to an end user device. In other embodiments, the method 300 does not include steps 312 and/or 314.

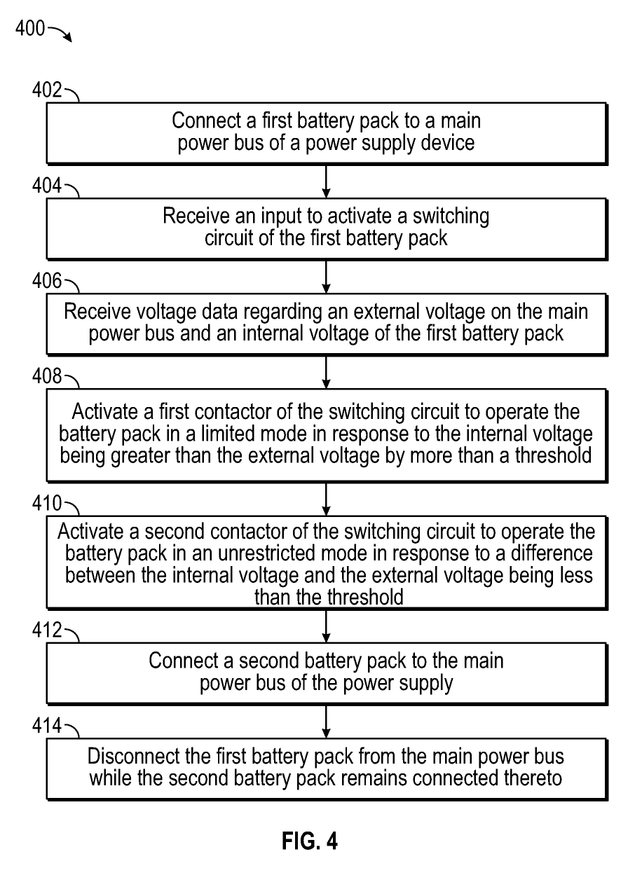

Referring now to FIG. 4, a method 400 for interchanging battery packs of a power supply device is shown according to another exemplary embodiment. In one exemplary embodiment, method 400 may be implemented with the battery pack 100 and the power supply device 10 of FIGS. 1 and 2. As such, method 400 may be described with regard to FIGS. 1 and 2.

At step 402, a first battery pack (e.g., the battery pack 100, etc.) is connected to a first interface (e.g., the power interface 32, the communication interface 34, etc.) of a main power bus (e.g., the main power bus 20, etc.) of a power supply device (e.g., the power supply device 10, etc.). At step 404, a controller (e.g., a BMS, the battery controller 140, etc.) of the first battery pack receives an input to activate a switching circuit (e.g., the switching circuit 150, etc.) of the first battery pack. By way of example, input may include a signal received by the controller from a switch (e.g., the external switch 152, etc.) of the first battery pack in response to an operator of the power supply device engaging the switch. By way of another example, the input may include a signal received by the controller from a sensor and/or a communication interface (e.g., the communication interface 138, etc.) of the battery pack in response to connection between the first battery pack and the main power bus.

At step 406, the controller is configured to receive voltage data regarding an external voltage on the main power bus (e.g., received from the communication interface 138, the voltage sensor 180, etc.) and an internal voltage of a battery (e.g., the battery 120, etc.) of the first battery pack (e.g., received from the cell monitors 124, etc.). At step 408, the controller is configured to activate a first contactor (e.g., the equalizing contactor 162, etc.) of the switching circuit to operate the battery pack in a limited mode in response to the internal voltage of the battery being greater than the external voltage by more than a threshold voltage amount. By way of example, activating the first contactor may direct current from a battery (e.g., the battery 120, etc.) to flow through a first circuit (e.g., the limited flow circuit 160, etc.) of the switching circuit prior to being provided to the main power bus (e.g., through the power interface 132, etc.). The first circuit may include a resistive element (e.g., the equalizing resistor 164, etc.) positioned and/or configured to modulate (e.g., limit, throttle, etc.) the power provided by the battery to the main power bus during the limited mode of operation.

At step 410, the controller is configured to activate a second contactor (e.g., the bypass contactor 172, etc.) of the switching circuit to operate the first battery pack in an unrestricted mode (e.g., in response to a determination that a difference between the internal voltage and the external voltage is less than the threshold voltage amount, within a predefined range of one another, etc.). By way of example, activating the second contactor may direct current from the battery to flow through a second circuit (e.g., the bypass circuit 170, etc.) that bypasses the resistive element.

At step 412, a second battery pack is connected to a second interface of the main power bus of the power supply device. The controller of the second battery pack may perform steps 404-410 similar to the controller of the first battery pack. At step 414, the first battery pack is disconnected from the main power bus while the second battery pack remains connected thereto (e.g., the power interface 132 of the battery pack 100 is disengaged from the power interface 32 of the power supply device 10, etc.). In one embodiment, disconnecting the first battery pack includes manually disengaging the switch. In another embodiment, disconnecting the first battery pack automatically disengages the switch. The controller may be configured to deactivate the first contactor and/or the second contactor in response to disengagement of the switch. In embodiments where the first battery pack may not include the switch, a signal may be sent to the controller from a sensor and/or a communication interface (e.g., the communication interface 138, etc.) of the first battery pack indicating a connection between the first battery pack and the main power bus has been disconnected. According to an exemplary embodiment, the battery packs facilitate interchangeably swapping battery packs such that the main power bus does not need to be powered down (e.g., hot-swappable battery packs, etc.), thereby being capable of providing continuous and uninterrupted power to an end user device. In other embodiments, the method 400 does not include steps 412 and/or 414.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the energy storage and power supply device as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A battery pack, comprising:
a housing;
one or more battery cells disposed within the housing;
a power interface including one or more connectors, wherein the one or more connectors are configured to engage with an interface of an external device to at least one of (i) charge the one or more battery cells and (ii) provide power from the one or more battery cells to the external device; and
a switching circuit including a limited flow circuit and a bypass circuit arranged in parallel between, and at least selectively electrically coupling, the one or more battery cells and the power interface;
wherein the limited flow circuit includes a resistor configured to at least selectively limit a flow of current between the one or more battery cells and the power interface; and
wherein the bypass circuit includes a switch configured to selectively place the one or more battery cells in direct electrical communication with the power interface.

2. The battery pack of claim 1, wherein the switch is configured to be opened in response to the power interface being disengaged from the interface of the external device.

3. The battery pack of claim 1, wherein the switching circuit is operable in a limited mode and an unrestricted mode when the power interface is engaged with the interface of the external device, wherein the switch is configured to be open during the limited mode such that the current flows along the limited flow circuit when the switching circuit is configured in the limited mode, and wherein the switch is configured to be closed during the unrestricted mode such that the current flows along the bypass circuit when the switching circuit is configured in the unrestricted mode.

4. The battery pack of claim 3, wherein the switch is a first switch, and wherein the limited flow circuit includes a second switch configured to be (i) closed during the limited mode and (ii) open or closed during the unrestricted mode.

5. The battery pack of claim 3, further comprising a controller configured to receive an input indicating that the power interface is engaged with the interface of the external device.

6. The battery pack of claim 5, further comprising a power switch, wherein the power switch provides the input to the controller in response to the power switch being at least one of (i) manually engaged by an operator and (ii) automatically engaged in response the power interface engaging with the interface of the external device.

7. The battery pack of claim 5, further comprising at least one of a sensor and a communications interface configured to provide the input to the controller in response to the power interface engaging with the interface of the external device.

8. The battery pack of claim 7, wherein the communications interface includes at least one of (i) one or more second connectors configured to engage with a second interface of the external device to facilitate transmitting information between the external device and the controller, and (ii) a wireless transceiver configured to facilitate wirelessly transmitting information between the external device and the controller.

9. The battery pack of claim 5, wherein the controller is configured to:
configure the switching circuit into the limited mode in response to receiving the input;
monitor the flow of the current being at least one of (i) provided to the one or more battery cells to charge the one or more battery cells and (ii) drawn from the one or more battery cells to power the external device; and
reconfigure the switching circuit from the limited mode into the unrestricted mode by closing the switch in response to the flow of the current dropping below a threshold current level.

10. The battery pack of claim 9, further comprising one or more cell monitors coupled to the one or more battery cells and the controller, the one or more cell monitors configured to acquire current data regarding the current flowing into and out of the one or more battery cells.

11. The battery pack of claim 5, wherein the controller is configured to:
monitor an external voltage of the external device and an internal voltage of the one or more battery cells;
configure the switching circuit into the limited mode in response to (i) receiving the input and (ii) a difference between the internal voltage and the external voltage being greater than a threshold voltage amount; and
reconfigure the switching circuit from the limited mode into the unrestricted mode by closing the switch in response the difference between the internal voltage and the external voltage being less than the threshold voltage amount.

12. The battery pack of claim 11, further comprising one or more cell monitors coupled to the one or more battery cells and the controller, the one or more cell monitors configured to acquire voltage data regarding the internal voltage of the one or more battery cells.

13. The battery pack of claim 11, further comprising a voltage sensor positioned proximate the power interface, the voltage sensor configured to acquire voltage data regarding the external voltage of the external device.

14. The battery pack of claim 11, further comprising a communications interface that includes at least one of (i) one or more second connectors configured to engage with a second interface of the external device to facilitate transmitting information between the external device and the controller, and (ii) a wireless transceiver configured to facilitate wirelessly transmitting information between the external device and the controller, wherein the communications interface is configured to receive voltage data regarding the external voltage of the external device from the external device.

15. The battery pack of claim 11, wherein the switch is a first switch, and wherein the limited flow circuit includes a second switch, wherein the controller is configured to close the second switch to configure the switching circuit into the limited mode.

16. A power supply system, comprising:
an electric device including a power bus having a plurality of power interfaces;
a plurality of battery packs, each of the plurality of battery packs including:
one or more battery cells;
a connector configured to selectively couple to one of the plurality of power interfaces;
a first circuit including at least one of a resistor and a first switch;
a second circuit including a second switch, the first circuit arranged in parallel with the second circuit between the one or more battery cells and the connector; and
a controller configured to control activation of at least one of the first switch and the second switch such that each of the plurality of battery packs are selectively engagable with and selectively disengagable from the power bus without impacting operation of the electric device.

17. The power supply system of claim 16, wherein the controller is configured to:
monitor current being at least one of (i) provided to the one or more battery cells to charge the one or more battery cells and (ii) drawn from the one or more battery cells to power the electric device; and
close the second switch in response to the current dropping below a threshold current level such that the current flows through the second circuit unrestricted by the resistor of the first circuit.

18. The power supply system of claim 17, wherein the first circuit includes the resistor and the first switch, and wherein the controller is configured to close the first switch and open the second switch in response to the connector engaging with the one of the plurality of power interfaces such that current flows through the resistor of the first circuit.

19. The power supply system of claim 16, wherein the controller is configured to:
monitor an external voltage on the power bus and an internal voltage of the one or more battery cells in response to the connector engaging with the one of the plurality of power interfaces;
close the first switch and open the second switch in response to a difference between the internal voltage and the external voltage being greater than a threshold voltage amount such that current flows through the resistor of the first circuit; and
close the second switch in response in response to the difference between the internal voltage and the external voltage being less than the threshold voltage amount such that the current flows through the second circuit unrestricted by the resistor of the first circuit.

20. A method for hot-swapping battery packs from an external device having a first battery pack and a second battery pack coupled thereto, comprising:
removing the first battery pack from a first power interface of the external device while leaving the second battery pack coupled to a second power interface of the external device;
coupling a third battery pack to the first power interface or a third power interface, the third battery pack including a switching circuit having (i) a first circuit including at least one of a resistor and a first switch and (ii) a second circuit in parallel with the first circuit and including a second switch;
monitoring, by a processing circuit of the third battery pack, at least one of a current flowing through the first circuit, an internal voltage of the third battery pack, and an external voltage of the external device; and
reconfiguring, by the processing circuit, the switching circuit from a limited mode, where the current flows through the resistor of the first circuit, to an unrestricted mode such that the current flows through the second circuit unrestricted by the resistor of the first circuit in response to at least one of (i) a difference between the internal voltage and the external voltage being less than a threshold voltage amount and (ii) the current dropping below a threshold current level, wherein reconfiguring the switching circuit from the limited mode to the unrestricted mode includes at least one of closing the second switch and opening the first switch.
